(19) United States
(12) Patent Application Publication
(10) Pub. No.: US 2026/0107095 A1
(43) Pub. Date: Apr. 16, 2026

(54) SUB-BAND ACOUSTIC FEEDBACK CANCELLATION WITH FORWARD-PATH DECORRELATION

(71) Applicant: SEMICONDUCTOR COMPONENTS INDUSTRIES, LLC, Scottsdale, AZ (US)

(72) Inventors: James Gregory RYAN, Ottawa (CA); Kyle James O'SHAUGHNESSY, Mississauga (CA)

(73) Assignee: SEMICONDUCTOR COMPONENTS INDUSTRIES, LLC, Scottsdale, AZ (US)

(21) Appl. No.: 19/312,024

(22) Filed: Aug. 27, 2025

Related U.S. Application Data
(60) Provisional application No. 63/707,936, filed on Oct. 16, 2024.

(51) Int. Cl. H04R 25/00

(52) U.S. Cl. CPC H04R 25/453; H04R 25/353

(57) ABSTRACT

An audio device is disclosed. The audio device includes a microphone and an input filter bank configured to decompose a microphone input signal into a plurality of sub-band input signals. The audio device further includes a plurality of sub-band channels configured to process the plurality of sub-band input signals to generate a plurality of sub-band output signals, wherein each of the plurality of sub-band channels are configured to subtract a respective one of a plurality of sub-band estimated acoustic-feedback signals from a respective one of the plurality of sub-band input signals, and wherein each of a subset of the plurality of sub-band channels are configured to frequency shift a respective sub-band output signal relative to a corresponding sub-band input signal. Further, the audio device includes an output filter bank configured to construct an output signal based on the sub-band output signals, and a speaker configured to output an audible signal.

This application claims the benefit of provisional patent application No. 63/707,936, filed Oct. 16, 2024, which is hereby incorporated by reference herein in its entirety.

### TECHNICAL FIELD

The disclosure relates generally to feedback cancellation in audio devices such as hearing aids, and in particular, and particularly to acoustic feedback cancellation with forward-path decorrelation.

### BACKGROUND

Audio devices, such as hearing aids, may output at a speaker an amplified signal received at a microphone. Acoustic feedback may occur when the output of the speaker is picked up by the microphone, amplified and then fed back into the speaker. Such acoustic feedback may be particularly troublesome for audio devices such as hearing aids, where the microphone is in close proximity to the speaker and a large amount of amplification is often applied to the microphone signal. When the amplification is high enough, the entire hearing aid system may become unstable, resulting in a loud, sustained whistling or howling sound emitted by the speaker of the audio device.

In traditional audio devices, feedback may be reduced by limiting the amplification of the microphone signal. While effective at reducing feedback, reducing the gain may render the hearing aid less effective at compensating for hearing loss. Further, inventors of embodiments of the present disclosure have recognized that a fixed gain reduction would not be able to adjust for changing feedback conditions, for example when a telephone, or other object, is brought close to the ear of a hearing aid user.

Conventional digital audio devices, such as conventional digitally implemented hearing aids, may employ adaptive feedback cancellers. Such an adaptive feedback canceller may estimate the feedback signal at the microphone and then subtract the feedback signal from the microphone signal. Because the feedback signal is cancelled at the microphone, a feedback canceller (FBC) may allow a higher acoustic gain to be achieved thereby improving the effectiveness of the hearing aid. Effective feedback cancellation relies on a close matching between the estimated and true feedback signals. Inventors of embodiments of the present disclosure have recognized, however, that because feedback conditions change over time, the feedback estimate must be constantly adjusted to ensure close matching to the true acoustic feedback. Inventors of embodiments of the present disclosure have also recognized that prior techniques for adjusting the feedback estimate have a difficulty in distinguishing between (i) feedback signals that are often in the form of a sinusoidal waves, and (ii) ambient tones that may also be sinusoidal in form, such as a beep from a microwave or a musical tone. Embodiments of the present disclosure may address one or more of these challenges.

### SUMMARY

The examples herein enable audio devices, for example, hearing aids, implemented to reduce or eliminate susceptibility to acoustic feedback.

According to one embodiments, an audio device is provided that includes a microphone, an input filter bank configured to decompose a microphone input signal into a plurality of sub-band input signals, a plurality of sub-band channels configured to process the plurality of sub-band input signals to generate a plurality of sub-band output signals, wherein each of the plurality of sub-band channels are configured to subtract a respective one of a plurality of sub-band estimated acoustic-feedback signals from a respective one of the plurality of sub-band input signals, and wherein each of a subset of the plurality of sub-band channels are configured to frequency shift a respective sub-band output signal relative to a corresponding sub-band input signal, an output filter bank configured to construct an output signal based on the plurality of sub-band output signals, and a speaker configured to output an audible signal based on the output signal. In some embodiments the audio device is a hearing aid. In the same or different embodiments, the subset is a proper subset including at least one and less than all of the plurality of sub-band channels. In the same or different embodiments, the frequency shift is constant across each of the subset of the plurality of sub-band channels. In the same or different embodiments, the frequency shift for each of the subset of sub-band channels is in a range of 5 to 25 Hz. In the same or different embodiments, the audio device further includes a limiter circuit coupled between the output filter bank and the speaker and configured to limit the output signal provided to the speaker based on a preprogrammed maximum level. In the same or different embodiments, the audio device further includes a feedback filter bank configured to decompose the output signal provided to the speaker into a plurality of sub-band feedback signals, and a plurality of sub-band feedback cancellers configured to respectively generate the plurality of sub-band estimated acoustic-feedback signals. In the same or different embodiments, each of the plurality of sub-band feedback cancellers includes an adaptive filter configured to generate a respective sub-band estimated acoustic-feedback signal based at least on a respective sub-band feedback signal and an input from a corresponding sub-band channel. In the same or different embodiments, each sub-band feedback canceller corresponding to a sub-band channel without the frequency shift further includes a tone detector coupled to detect a tone from the corresponding sub-band channel, and an adaptation controller configured to select a first adaptation rate for the adaptive filter if the tone is detected by the tone detector and if a total gain for the corresponding sub-band channel is greater than a threshold, and to select a second adaptation rate that is slower than the first adaptation rate for the adaptive filter if no tone is detected by the tone detector or the total gain for the corresponding sub-band channel is less than the threshold. In the same or different embodiments, the audio device further includes a tone detector coupled to detect a tone from the corresponding sub-band channel, and an adaptation controller configured to select a first adaptation rate for the adaptive filter if no tone is detected by the tone detector and select a second adaptation rate that is slower than the first adaptation rate for the adaptive filter if the tone is detected by the tone detector.

According to another embodiment, an audio device is provided that includes a microphone, an input filter bank configured to decompose a microphone input signal into a plurality of sub-band input signals, a plurality of sub-band channels configured to process the plurality of sub-band input signals to generate a plurality of sub-band output signals, wherein each of the plurality of sub-band channels includes a gain circuit coupled to a summation circuit that is configured to subtract a respective one of the plurality of sub-band estimated acoustic-feedback signals from a respective one of the plurality of sub-band input signals, and wherein each of a subset of the plurality of sub-band channels further includes a multiplier configured to frequency shift a respective sub-band output signal relative to a corresponding sub-band input signal, an output filter bank configured to construct an output signal based on the plurality of sub-band output signals, and a speaker configured to output an audible signal based on the output signal. In some embodiments, the subset is a proper subset including at least one and less than all of the plurality of sub-band channels. In the same or different embodiments, the frequency shift is constant across each of the subset of the plurality of sub-band channels.

Another example provides a method of operating an audio device including decomposing a microphone input signal into a plurality of sub-band input signals, processing the plurality of sub-band input signals with a plurality of sub-band channels to generate a plurality of sub-band output signals, wherein the processing includes subtracting respectively a plurality of sub-band estimated acoustic-feedback signals from the plurality of sub-band input signals and providing a frequency shift to a subset of the plurality of sub-band output signals, constructing an output signal based on the plurality of sub-band output signals, and outputting with a speaker an audible signal based on the output signal. In some embodiments, the method further includes decomposing the output signal provided to the speaker into a plurality of sub-band feedback signals, and generating each of the plurality of sub-band estimated acoustic-feedback signals with an adaptive filter based on respective sub-band feedback signals and an input from a respective corresponding sub-band channel. In the same or different embodiments, the method further includes detecting whether a tone is present in a sub-band channel with a tone detector, and controlling a rate of adaptation of the adaptive filter based at least in part on whether a tone is detected. In the same or different embodiments, and for one or more adaptive filters corresponding to one or more sub-band channels without a frequency shift, the method further includes selecting a first adaptation rate if the tone is detected by the tone detector and if a total gain for the sub-band channel is greater than a threshold, and selecting a second adaptation rate that is slower than the first adaptation rate if no tone is detected by the tone detector or the total gain for the sub-band channel is less than the threshold. In the same or different embodiments, and for one or more adaptive filters corresponding to the subset of the plurality of sub-band channels with a frequency shift, the method further includes selecting a first adaptation rate if no tone is detected by the tone detector, and selecting a second adaptation rate that is slower than the first adaptation rate if the tone is detected by the tone detector. In the same or different embodiments, the subset is a proper subset including at least one and less than all of the plurality of sub-band channels. In the same or different embodiments, the frequency shift is constant across each of the subset of the plurality of sub-band channels. In the same or different embodiments, the frequency shift for each of the subset of sub-band channels is in a range of 5 to 25 Hz.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1 illustrates a schematic diagram of an audio device in accordance with embodiments of the present disclosure.

FIG. 2A illustrates a schematic diagram of an audio device in accordance with embodiments of the present disclosure.

FIG. 2B illustrates a table of operating conditions for an audio device in accordance with embodiments of the present disclosure.

FIG. 3 illustrates an example plot of the gain of an acoustic feedback path in accordance with embodiments of the present disclosure.

FIG. 4 illustrates a schematic diagram of an audio device in accordance with embodiments of the present disclosure.

FIG. 5A illustrates a schematic diagram of an audio device in accordance with embodiments of the present disclosure.

FIG. 5B illustrates a table of operating conditions for an audio device in accordance with embodiments of the present disclosure.

FIG. 5C illustrates a table of operating conditions for an audio device in accordance with embodiments of the present disclosure.

FIG. 6 illustrates a method for operating an audio device in accordance with embodiments of the present disclosure.

FIG. 7 illustrates a method for operating an audio device in accordance with embodiments of the present disclosure.

FIG. 8 illustrates a method for operating an audio device in accordance with embodiments of the present disclosure.

### DETAILED DESCRIPTION

Details of one or more embodiments are set forth in the description below and the accompanying drawings. Other features will be apparent from the description, drawings, and from the claims. The embodiments disclosed should not be interpreted, or otherwise used, as limiting the scope of the disclosure, including the claims. In addition, one skilled in the art understands that the following description has broad application, and the discussion of any embodiment is meant to be exemplary of that embodiment, and not intended to intimate that the scope of the disclosure, including the claims, is limited to that embodiment.

Various terms are used to refer to particular system components. Different companies may refer to a component by different names, and this disclosure does not intend to distinguish between components that differ in name but not form and function. In the following discussion and in the claims, the terms “including” and “comprising” are used in an open-ended fashion, and thus should be interpreted to mean “including, but not limited to.” Also, the term “couple” or “coupled” is intended to encompass either an indirect connection or a direct connection. Thus, if a first device couples to, or is coupled to, a second device, that connection between the first device and the second device may be through a direct connection or through an indirect connection via other devices and connections.

Further, although the terms “first,” “second,” and so forth may be used herein to describe various elements, these elements should not be limited by these terms. Terms such as “first” and “second” may be used merely to distinguish one element from another. For example, a first element could be termed a second element, and, similarly, a second element could be termed a first element, without departing from the scope of the present disclosure. Further, the identification of a “first” element, does not necessarily require the presence of a “second” element. As used herein, the term “and/or” includes any and all combinations of one or more of the associated listed items.

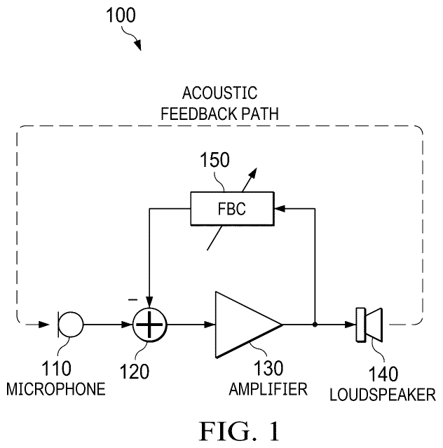

FIG. 1 illustrates a schematic diagram of an audio device 100 in accordance with embodiments of the present disclosure. Audio device 100 may be, for example, a hearing aid. As shown in FIG. 1, audio device 100 may include microphone 110, amplifier 130, and speaker 140. The primary goal of audio device 100 may be to amplify sounds so that the acoustic level output by speaker 140 to the ear of the wearer is louder than the sound received at microphone 110. However, some of the sound output by speaker 140 may leak back to microphone 110, creating an acoustic feedback path. Sound from the acoustic feedback path may be picked up by microphone 110 and amplified. At low gain settings, the feedback can be heard as a tinniness or as a ringing sound for example. At high gain settings, the feedback can cause audio device 100 to become unstable and result in sustained oscillation or howling. To prevent such unstable operation, audio device 100 may further include feedback cancellation (FBC) circuit 150.

Feedback cancellation circuit 150 may have an input coupled to the output of amplifier 130 and an output coupled to summation circuit 120. Feedback cancellation circuit may create an estimate of the acoustic feedback by filtering the output of amplifier 130. And as indicated in FIG. 1, summation circuit 120 may subtract the estimated acoustic feedback from the microphone signal and provide the result to the input of amplifier 130. Accordingly, the estimated acoustic feedback may be subtracted from the microphone signal, thereby reducing or eliminating the effects of the actual acoustic feedback.

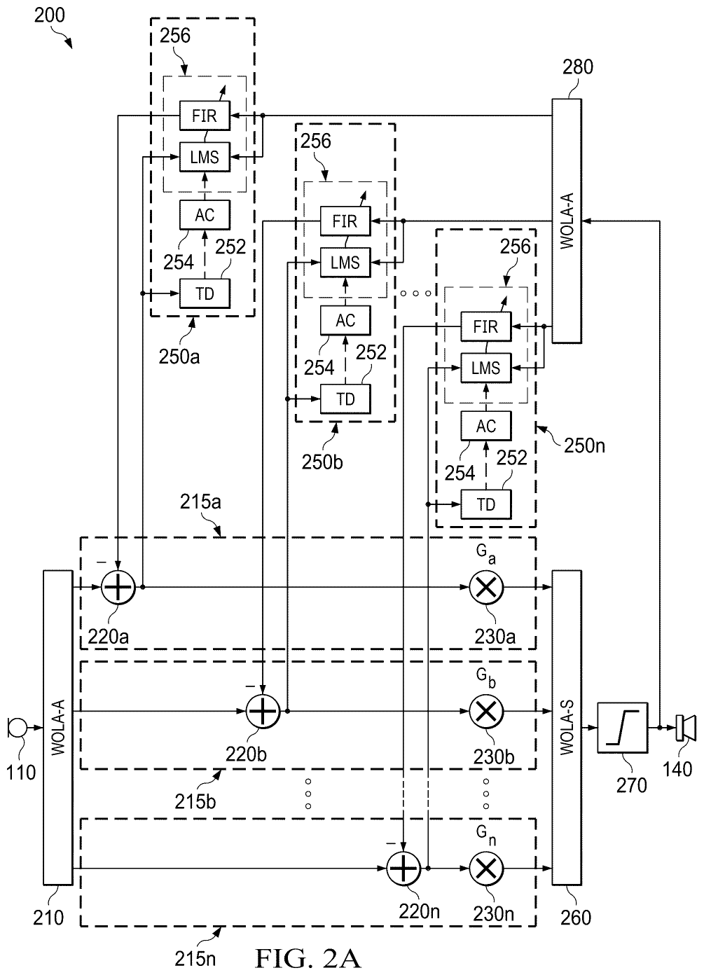

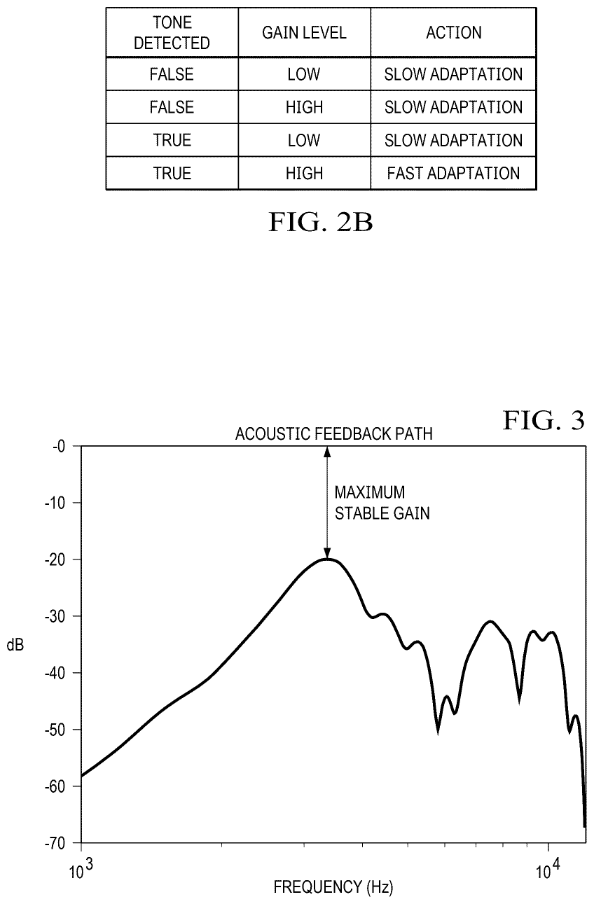

FIG. 2A illustrates a schematic diagram of an audio device 200 in accordance with embodiments of the present disclosure. As shown in FIG. 2A, audio device 200 may include microphone 110, input filter bank 210, a plurality of sub-band channels 215a-n, output filter bank 260, limiter circuit 270, speaker 140, feedback filter bank 280, and sub-band feedback cancellers 250a-n.

Input filter bank 210 may be configured to decompose a microphone input signal into a plurality of sub-band input signals. Specifically, input filter bank 210 may decompose a time-domain microphone input signal into an n number of sub-band input signals. In some embodiments, input filter bank 210 may be a weighted overlap-add (WOLA) filterbank, and specifically a WOLA analysis (WOLA-A) filterbank.

The sub-band input signals may be respectively provided to the plurality of sub-band channels 215a-n, which may be configured to process the plurality of sub-band input signals to generate a plurality of sub-band output signals to be provided to output filter bank 260. For example, each of the plurality of sub-band channels 215a-n may be configured to subtract a respective one of a plurality of sub-band estimated acoustic feedback signals from a respective one of the plurality of sub-band input signals and to then amplify the compensated result. As shown in FIG. 2A, each of the plurality of sub-band channels 215a-n may include a respective one of the plurality of summation circuits 220a-n and a respective one of the plurality of gain circuits 230a-n. Summation circuits 220a-n may subtract the estimated feedback (provided by sub-band feedback cancellers 250a-n) for each respective sub-band from the sub-band input signals to compensate for the effects of the actual acoustic feedback. The summation circuits 220a-n may output the results to the respective gain circuits 230a-n. The gain circuits 230a-n may in turn amplify the compensated sub-band input signals and pass the amplified sub-band signals to output filter bank 260. Although not illustrated in FIG. 2A, gain circuits 230a-n may include various audio processing functions, such as automatic gain control and noise reduction, that may be useful in hearing-aid and other applications.

In some embodiments, output filter bank 260 may be a WOLA synthesis (WOLA-S) filterbank performing the reverse of the process of input filter bank 210. For example, output filter bank 260 may be configured to construct an output signal based on the plurality of sub-band output signals from the plurality of sub-band channels 215a-n. Specifically, output filter bank 260 may receive the various amplified sub-band output signals from the plurality of sub-band channels 215a-n and reconstruct a time-domain output signal from the sub-band representation. The reconstructed time-domain output signal may be provided to limiter circuit 270. As shown in FIG. 2A, limiter circuit 270 may be coupled between output filter bank 260 and speaker 140. Further, limiter circuit 270 may be configured to limit the output signal provided to the speaker based on preprogrammed maximum level. Accordingly, limiter circuit 270 may ensure that the audible output of speaker 140 does not exceed a maximum level.

The output signal to speaker 140 may also be provided to feedback filter bank 280. In some embodiments, feedback filter bank 280 may be a WOLA-A filter bank matching input filter bank 210. Accordingly, feedback filter bank 280 may be configured to decompose the output signal provided to speaker 140 into a plurality of sub-band feedback signals. Specifically, feedback filter bank 280 may decompose the output signal provided to speaker 140 into a matching n number of sub-band feedback signals, based on which the sub-band feedback cancellers 250a-n may determine the estimated feedback for cancellation. As described in further detail below, the plurality of sub-band feedback cancellers 250a-n may be configured to respectively generate the plurality of sub-band estimated acoustic-feedback signals, which summation circuits 220a-n may respectively subtract from the sub-band input signals.

As shown in FIG. 2A, the same structure may be used for each sub-band. Accordingly, the signals within each sub-band may be treated in a similar manner to their time-domain counterparts, thus reducing or eliminating information loss. For simplicity, only three of the sub-bands are illustrated in FIG. 2A. However, in various embodiments, audio device 200 may include any suitable n number of sub-bands. For example, in hearing-aid applications, audio device 200 may include 8, 16, 24, 32, 48, or more different sub-bands. The respective sub-bands may be divided evenly across a range of frequencies, including frequencies in the human audible frequency range (20 Hz to 20 kHz). For example, the n number of sub-bands may be divided evenly in a range from 0 Hz to 12, 14, 16, 18, or 20 kHz.

As described above, feedback filter bank 280 may decompose the time-domain output signal provided to speaker 140 into an n number of sub-band feedback signals, based on which sub-band feedback cancellers 250a-n may generate the plurality of sub-band estimated acoustic-feedback signals. As shown in FIG. 2A, each of the plurality of sub-band feedback cancellers 250a-n may include an adaptive filter 256. Each instance of adaptive filter 256 may be coupled to receive a respective sub-band feedback signal (from feedback filter bank 280) and an input from a corresponding one of the plurality of sub-band channels 215a-n. Adaptive filter 256 may thus be configured to generate a respective sub-band estimated acoustic-feedback signal based at least on the respective sub-band feedback signal (from feedback filter bank 280) and an input from a corresponding one of sub-band channels 215a-n.

In some embodiments, adaptive filter 256 may include a Finite Impulse Response (FIR) filter. The FIR filter coefficients represent the feedback-path model and, when correctly converged, will approximate the truncated impulse response of the feedback path. In addition to the FIR filter, adaptive filter 256 may include a Least Mean Squares algorithm to adjust the FIR filter coefficients. The LMS algorithm is a form of gradient-descent algorithm that adjusts the coefficients of an adaptive filter (such as adaptive filter 256) to minimize the error between the filter output and a desired target signal.

The LMS algorithm can be described by the following equations:

$$Step 1 - Compute the FIR filter output : y ( k ) = {\sum }_{k = 0}^{N - 1} {h}_{k}^{*} ( n ) x ( n - k )$$

$$Step 2 - Compute the error signal : e ( n ) = m ( n ) - y ( n )$$

$$Step 3 - Compute new filter coefficients : {h}_{k} ( n + 1 ) = {h}_{k} ( n ) + μ {e}^{*} ( n ) x ( n - k )$$

In the above equations, x(n) and y(n) are the FIR filter input and output respectively, hₓ(n) is the k^{th} FIR filter coefficient at time n, N is the number of FIR taps, m(n) is the microphone signal, e(n) is the error signal and μ is an adaptive step size parameter that controls the speed of convergence. The superscript * denotes the complex conjugate since the sub-band signals and FIR filter coefficients are complex quantities. Adaptation of the LMS algorithm is controlled by selecting an appropriate step size, u. Larger values for u may result in larger coefficient updates on each iteration and result in faster adaptation. Conversely, smaller values for u may result in smaller coefficient updates and result in slower adaptation.

The LMS algorithm is based on a correlation between the filter input signal and difference between the microphone and filter output signals (usually called the error signal). A high correlation between the error and filter input will drive the filter coefficients to a value that models this correlation. If the correlation is due to actual feedback, the filter converges to an estimate of that feedback.

Adaptation speed may also be affected by signal amplitude. For a constant step size u, when the signal levels become very small, the LMS updates may also become very small, and the coefficient adaptation may slow down. This can create uneven adaptation behavior in realistic situations. Accordingly, a modified version of the LMS algorithm known as the Normalized LMS algorithm (NLMS) may be employed. In the Normalized LMS algorithm, the coefficient update equation in Step 3 may be modified to account for the x(n) signal level. The modified Step 3 may be described as:

$${h}_{k} ( n + 1 ) = {h}_{k} ( n ) + \frac{μ {e}^{*} ( n ) x ( n - k )}{{\sum }_{k = 0}^{N - 1} {\vert {x}^{2} ( n - k ) \vert}^{2} + δ}$$

where δ is a small, positive constant included to avoid division by zero. Alternate forms of the normalized LMS algorithm may also be implemented that, for example use the e(n) signal level in combination with the x(n) signal level.

Effective feedback cancellation relies on a close matching between the estimated and true feedback signals. Because feedback conditions may change over time, the feedback estimate may be frequently adjusted to ensure close matching to the true acoustic feedback. However, if the acoustic feedback conditions are constant, the feedback estimate may also be held constant because unnecessary adjustment of the feedback estimate may lead to a mismatch with the real acoustic feedback signal rendering the cancellation ineffective.

When an audio device (such as audio device 200) exhibits sustained feedback, the audio device may output from the speaker a tone-like sound whose frequency may be related to the peak frequency response of the acoustic feedback path. Due to the acoustic feedback, such a tonal signal may also be picked up by microphone 110. Accordingly, the presence of a tone in the microphone signal may indicate the presence of acoustic feedback. The potential presence of acoustic feedback may warrant fast adaptation. Conversely, if no tone is observed, acoustic feedback is not likely occurring, and slow adaptation may be used to preserve audio quality.

As shown in FIG. 2A, each of the sub-band feedback cancellers 250a-n may include a tone detector 252 and an adaptation controller 254. Each tone detector 252 may be coupled to detect a tone from a corresponding one of the sub-band channels 215a-n. The tones may be detected based on the sub-band input signal either before or after the cancellation provided at the respective summation circuits 220a-n. For example, in the embodiment shown in FIG. 2A, the tone detector 252 for each sub-band may be respectively coupled to detect tones from the output of the corresponding one of summation circuits 220a-n. In other embodiments, the tone detector 252 for each sub-band may be respectively coupled to detect tones at the inputs of the corresponding one of summation circuits 220a-n. Upon detection of a tone, tone detector 252 may instruct adaptation controller 254 to initiate a fast adaptation rate. Otherwise, in the absence of a detected tone, tone detector 252 may instruct adaptation controller 254 to maintain a slow adaptation rate. In some embodiments, adaptation controller 254 may control the step size parameter u based on the detection of a tone. As described above, adaptation-speed control may be exercised using the LMS step size parameter, u. Larger values for u result in faster adaptation and smaller values result in slower adaptation. In some embodiments, fast and slow adaptation rates may be chosen based on values for u saved in a memory (not shown in FIG. 2A) and based, for example, on experimental results. Further, the LMS step size parameter, u, may have an upper limit to ensure the stability of the LMS algorithm.

The tone detection illustrated in FIG. 2A may in some embodiments be augmented with further information measured from the input signals and/or derived from the operation of audio device 200. As described below, such augmentation may help prevent the adaptation control scheme from falsely responding to tone-like acoustic signals received by microphone 110, such as music, chimes, and/or beeping indicators from household appliances. In some embodiments, the risk of acoustic feedback may be estimated based on the gain of audio device 200 and an estimate of the acoustic feedback-path response. In embodiments where audio device 200 is a hearing aid, for example, the overall gain of the hearing aid may be comprised of contributions from the various audio-processing, such as wide dynamic range compression (WDRC) and noise reduction (NR), that may be included therein. The combined gain resulting from such features may be calculated to get an accurate estimate of the real-time gain. Further, the acoustic feedback-path response may be estimated from the coefficients of the adaptive filter. Based on this information, the risk of feedback at a specific frequency can be flagged when the total gain for a given sub-band exceeds a threshold derived from the estimated acoustic feedback-path level and a pre-determined offset that may protect from inaccuracies in either the gain calculation or the acoustic feedback estimate which may arise during operation of the device.

FIG. 3 illustrates an example plot of the gain of an acoustic feedback path in accordance with embodiments of the present disclosure. As described above, the gain of the acoustic feedback path may change under varied conditions, for example, when a telephone or other object is brought close to the ear of a user in applications where audio device 200 is implemented as a hearing aid. Nonetheless, for illustration purposes, an example plot of the gain of the acoustic feedback path of audio device 200 is shown in FIG. 3. To maintain stable operation, the sum of the gain of the acoustic feedback path plus the forward gain of audio device 200 at a given frequency must be equal to zero or less. Under the conditions illustrated in FIG. 3, the peak gain of the acoustic feedback path may be, for example, −20 dB at around 3.3 kHz. Accordingly, to maintain stable operation under the conditions of FIG. 3, the maximum forward gain that may be applied by audio device 200 in the sub-band including 3.3 kHz would be +20 dB.

As described above with reference to FIG. 2A, the response (or gain) of the acoustic feedback path for audio device 200 may also be estimated from the coefficients of the respective adaptive filters within sub-band feedback cancellers 250a-n. Audio device 200 may thus determine the maximum gain that may be applied in each sub-band to maintain stable operation. In some embodiments, an additional offset may be included to protect from inaccuracies in either the gain calculation or the acoustic feedback estimate. Referring back to FIG. 2B, audio device 200 may utilize the maximum stable gain as a threshold for determining whether to select a fast adaptation rate or a slow adaptation rate.

FIG. 2B illustrates a table of operating conditions for audio device 200 in accordance with embodiments of the present disclosure. When no tone is detected for a given sub-band, a slow adaptation may be selected for that sub-band regardless of the gain level for that sub-band. When a tone is detected for a given sub-band and the total gain level for that sub-band is above a threshold (derived based on the estimated acoustic feedback-path level and a pre-determined offset), a fast adaptation may be selected for that sub-band. However, when a tone is detected for a given sub-band and the total gain level for that sub-band is below the threshold, a slow adaptation may be selected for that sub-band. By augmenting the sub-band tone detection with additional information regarding the maximum stable gain that may be applied for a given sub-band, the adaptation control scheme may be prevented from falsely responding to tone-like acoustic signals received by microphone 110, such as music, chimes, and/or beeping indicators from household appliances, at least when the gain for a given sub-band is less than the maximum stable gain threshold. Inventors of embodiments of the present disclosure have recognized that entrainment may nonetheless occur under conditions when the gain of a given sub-band exceeds the maximum stable gain threshold and the respective one or more of the sub-band feedback cancellers 250a-n adapt quickly in response to an ambient tone as opposed to actual acoustic feedback. Thus, as described in further detail below, the performance of various embodiments of the present disclosure may be further improved by including mechanisms to decorrelate the input of the audio device at microphone 110 and the output of the audio device at speaker 140, thereby providing further measures to prevent entrainment.

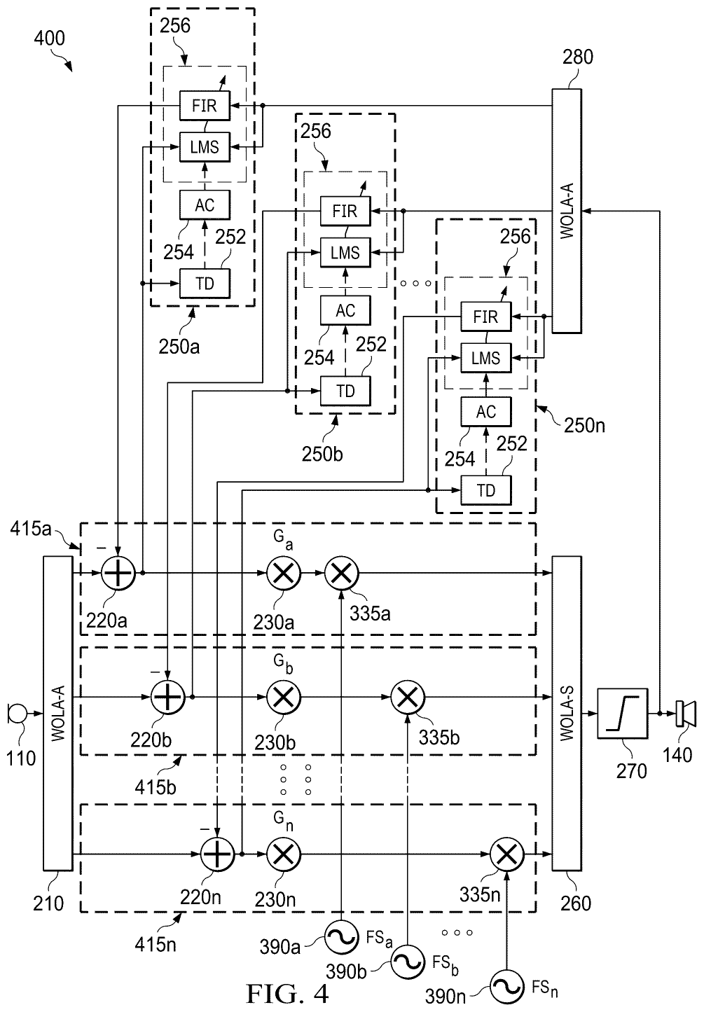

FIG. 4 illustrates a schematic diagram of audio device 400 in accordance with embodiments of the present disclosure. Audio device 400 may include microphone 110, input filter bank 210, output filter bank 260, limiter circuit 270, speaker 140, feedback filter bank 280, and sub-band feedback cancellers 250a-n, which may each operate in a similar manner as described above with reference to FIG. 2A. Further, audio device 400 may include a plurality of sub-band channels 415a-n configured to process the plurality of sub-band input signals from input filter bank 210 to generate a plurality of sub-band output signals to be provided to output filter bank 260. The plurality of sub-band channels 415a-n may each include a respective one of a plurality of summation circuits 220a-n, and a respective one of a plurality of gain circuits 230a-n, which may also operate in a similar manner as described above with reference to FIG. 2A.

In addition, the respective sub-band channels 415a-n of audio device 400 may include a plurality of multipliers 335a-n. As described in further detail below, the plurality of multipliers 335a-n may provide a decorrelation mechanism in the forward path that may help to eliminate the bias in the respective estimates by the plurality sub-band feedback cancellers 250a-n of the acoustic feedback that would otherwise arise due to the fact that the signal used in the LMS updates of the respective sub-band feedback cancellers 250a-n are correlated to the input from input filter bank 210.

As shown in FIG. 4, the plurality of multipliers 335a-n may each have a first input coupled to receive a respective one of the amplified sub-band signals from gain circuits 230a-n, a second input coupled to receive a respective one of a plurality of frequency-shift signals from frequency-shift sources 390a-n, and an output coupled to output filter bank 260. Accordingly, the plurality of multipliers 335a-n may be configured to shift the respective frequencies of amplified sub-band signals from gain circuits 230a-n before those amplified sub-band signals are reconstructed into a collective time-domain signal by output filter bank 260. By shifting the frequency of the various sub-band output signals, multipliers 335a-n may provide forward-path decorrelation.

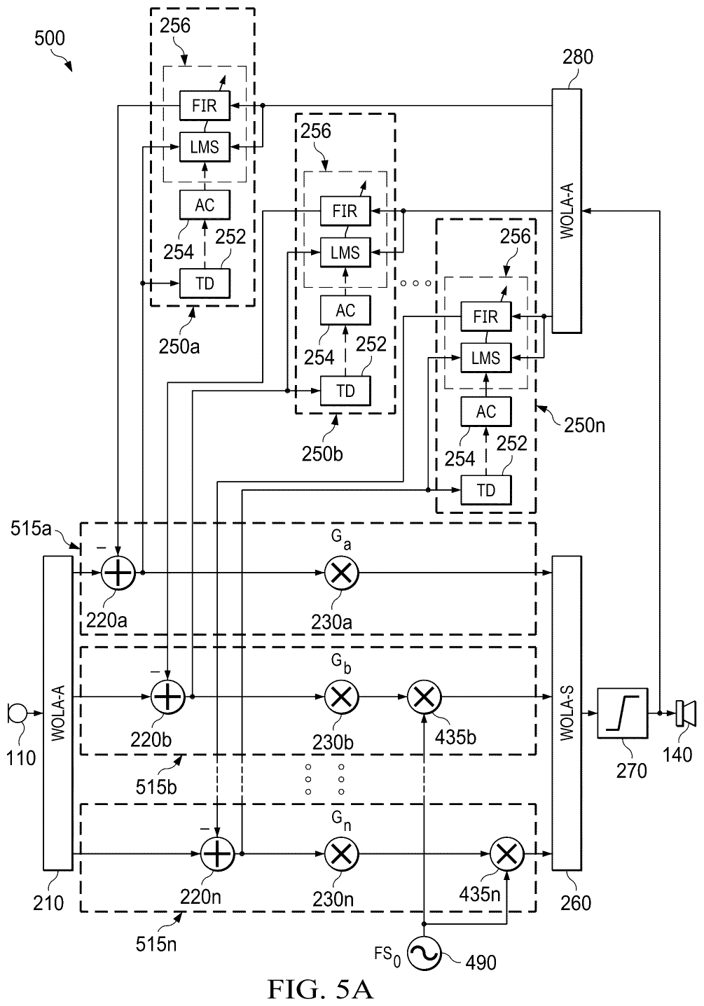

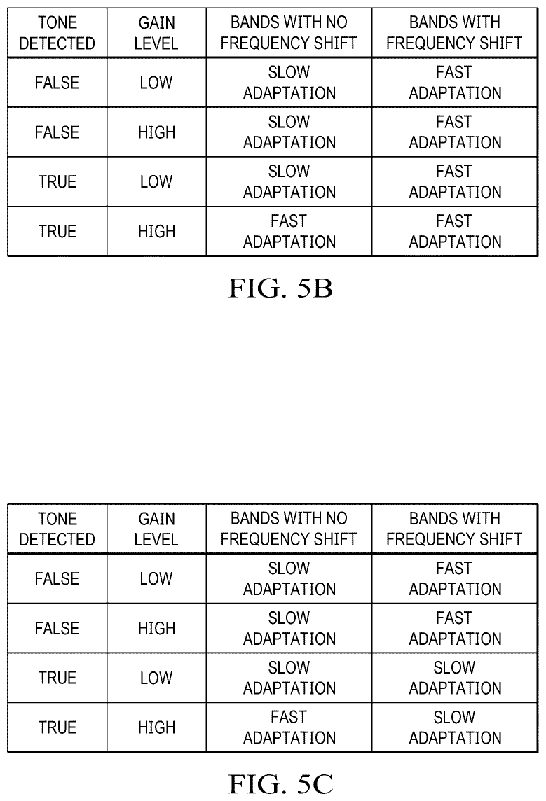

The plurality of multipliers 335a-n and the corresponding frequency-shift sources 390a-n may provide for a frequency shift in each sub-band that achieves the dual goal of being large enough to provide effective decorrelation and also being small enough to limit or avoid audible distortion. In some embodiments, the plurality of multipliers 335a-n and the corresponding frequency-shift sources 390a-n may each provide a frequency shift in the range of 5 to 48 Hz. In other embodiments, the plurality of multipliers 335a-n and the corresponding frequency-shift sources 390a-n may each provide a frequency shift in the range of 5 to 25 Hz. The frequency shift may vary or may be constant across the different sub-bands. For example, in some embodiments, the frequency shift may be smaller for one or more lower-frequency sub-bands and may be larger for one or more higher-frequency sub-bands. In other embodiments, the frequency shift may be constant (for example at a frequency between 5 and 25 Hz) for each sub-band. Further, as described below with reference to FIGS. 5A-5C, some embodiments of the present disclosure may include a first one or more sub-bands with no frequency shift and a second one or more sub-bands with a constant frequency shift.

FIG. 5A illustrates a schematic diagram of audio device 500 in accordance with embodiments of the present disclosure. Audio device 500 may include microphone 110, input filter bank 210, output filter bank 260, limiter circuit 270, speaker 140, feedback filter bank 280, and sub-band feedback cancellers 250a-n, which may each operate in a similar manner as described above with reference to FIG. 2A. Further, audio device 500 may include a plurality of sub-band channels 515a-n configured to process the plurality of sub-band input signals from input filter bank 210 to generate a plurality of sub-band output signals to be provided to output filter bank 260. The plurality of sub-band channels 515a-n may each include a respective one of a plurality of summation circuits 220a-n, and a respective one of a plurality of gain circuits 230a-n, which may also operate in a similar manner as described above with reference to FIG. 2A.

In addition, and as shown in FIG. 5A, each of a subset of the plurality of sub-band channels 515a-n may be configured to frequency shift a respective sub-band output signal relative to a corresponding sub-band input signal. For example, each of a subset of the plurality of sub-band channels may further include a multiplier configured to frequency shift a respective sub-band output signal relative to a corresponding sub-band input signal. As shown in FIG. 5A, for example, the amplified sub-band signal from gain circuit 230a may be provided directly to output filter bank 260 with no frequency shift, while the respective amplified sub-band signals from gain circuits 230b through 230n may be frequency-shifted by multipliers 435b through 435n before being received by output filter bank 260. The multipliers (such as multipliers 435b and 435n shown in FIG. 5A) may provide a decorrelation mechanism in the forward path that may help to eliminate the bias in the respective feedback estimates by the corresponding sub-band feedback cancellers (such as sub-band feedback cancellers 250b and 250n).

As shown in FIG. 5A, the multipliers (such as multipliers 435b and 435n) may each have a first input coupled to receive a respective one of the amplified sub-band signals from gain circuits 230a-n, a second input coupled to receive a frequency-shift signal from frequency-shift source 490, and an output coupled to output filter bank 260. Accordingly, multipliers (such as multipliers 435b and 435n) may be configured to shift the respective frequencies of amplified sub-band signals from the gain circuits (such as gain circuits 230b and 230n) before those amplified sub-band signals are reconstructed into a collective time-domain signal by output filter bank 260. By shifting the frequency of the various sub-band output signals, the multipliers (such as multipliers 435b and 435n) may provide forward-path decorrelation.

For simplicity, only three sub-bands are illustrated in FIG. 5A. However, in various embodiments, audio device 500 may include any suitable n number of sub-bands. For example, in hearing-aid applications, audio device 500 may include 8, 16, 24, 32, 48, or more different sub-bands. The respective sub-bands may be divided evenly across a range of frequencies, including frequencies in the human audible frequency range (20 Hz to 20 kHz). For example, the n number of sub-bands may be divided evenly in a range from 0 Hz to 12, 14, 16, 18, or 20 kHz.

Although FIG. 5A illustrates two sub-band channels with a frequency shift (for example, sub-band channels 515b and 515n) and one sub-band channel without a frequency shift (for example, sub-band channel 515a), any suitable subset of one or more sub-band channels may include a frequency shift while any remaining one or more sub-band channels do not include the frequency shift. For example, the subset of sub-band channels with a frequency shift may be a proper subset including at least one and less than all of the plurality of sub-band channels 515a-n.

In some embodiments, one or more higher-frequency sub-band channels (such as sub-band channels 515b and 515n) may include a frequency shift while one or more lower-frequency sub-band channels (such as sub-band channel 515a) may omit the frequency shift. For example, audio device 500 may include a first set of one or more sub-band channels (such as sub-band channels 515b and 515n) with a frequency shift, and a second set of one or more sub-band channels (such as sub-band channel 515a) without the frequency shift, wherein each of the second set of one or more sub-band channels operate at lower frequencies than each of the first set of one or more sub-band channels.

In some embodiments, the frequency shift may be constant across each of the subset of the plurality of sub-band channels that have the frequency shift. For example, as shown in FIG. 5A, multipliers 435b through 435n may each include an input coupled to the same frequency-shift source 490 in order to provide the same degree of frequency shift across the subset of sub-band channels that include the frequency shift. By using a frequency shift that is constant across the subset of sub-band channels, the circuitry used to implement the frequency shift may be simplified. The level of the frequency shift may be designed to achieve the dual goal of being large enough to provide effective decorrelation and also being small enough to limit or avoid audible distortion in the human-audible frequency ranges. In some embodiments, the frequency shift for each of the subset of sub-band channels may be in a range of 5 to 25 Hz. For example, frequency-shift source 490 and the respective multipliers (such as multipliers 435b through 435n) may each provide a constant frequency shift across the subset of sub-band channels (such as sub-band channels 515b through 515n) in the range of 5 to 25 Hz. In other embodiments, the frequency shift for each of the subset of sub-band channels may be in a range of 5 to 48 Hz. For example, frequency-shift source 490 and the respective multipliers (such as multipliers 435b through 435n) may each provide a constant frequency shift across the subset of sub-band channels (such as sub-band channels 515b through 515n) in the range of 5 to 25 Hz.

Similar to the description above for audio device 200 in FIG. 2A, the tone detection for audio device 500 in FIG. 5A (or for audio device 400 in FIG. 4) may in some embodiments be augmented with further information measured from the input signals and/or derived from the operation of the audio device. In addition to the frequency shift for certain sub-band channels described above, such augmentation may help prevent the adaptation control scheme from falsely responding to tone-like acoustic signals received by microphone 110, such as music, chimes, and/or beeping indicators from household appliances. In some embodiments, the risk of acoustic feedback may be estimated based on the gain of audio device 500 and an estimate of the acoustic feedback-path response. In embodiments where audio device 500 is a hearing aid, for example, the gain of the hearing aid may be comprised of contributions from the various audio-processing, such as wide dynamic range compression (WDRC) and noise reduction (NR), that may be included therein. The combined gain resulting from such features may be calculated to get an accurate estimate of the real-time gain for the various sub-channels. Further, the acoustic feedback-path response may be estimated from the coefficients of the respective adaptive filter 256. Based on this information, the risk of feedback at a specific frequency can be flagged when the total gain for a given sub-band exceeds a threshold derived from the estimated acoustic feedback-path level and a pre-determined offset that may protect from inaccuracies in either the gain calculation or the acoustic feedback estimate which may arise during operation of the device.

The gain of the acoustic feedback path for audio device 500 may be estimated from the coefficients of the respective adaptive filters within sub-band feedback cancellers 250a-n. Audio device 500 may thus determine maximum gain that may be applied in each sub-band to maintain stable operation. For example, as described above with reference to FIG. 3, if the acoustic feedback path for an audio device has a peak gain of −20 dB at around 3.3 kHz, the maximum stable gain for that audio device in the sub-band including 3.3 kHz would be +20 dB to maintain stable operation. Further, an additional offset may be included to protect from inaccuracies in either the gain calculation or the acoustic feedback estimate. Referring next to FIGS. 5B and 5C, audio device 500 may utilize the maximum stable gain as a threshold for determining whether to select a fast adaptation rate or slow adaptation rate.

FIG. 5B illustrates a table of operating conditions for audio device 500 in accordance with some embodiments of the present disclosure. As shown in FIG. 5B, the operation matrix may differ for sub-band channels with a frequency shift and sub-band channels without a frequency shift. For sub-band channels that include a frequency shift, the risk of entrainment may be reduced or avoided due to the decorrelation provided by the frequency shift. Accordingly, the respective sub-band feedback cancellers (such as sub-band feedback cancellers 250b and 250n in FIG. 5A) corresponding to sub-band channels with a frequency shift may be programmed to have a fast adaptation rate regardless of the calculated forward gain level and whether a tone is detected. Meanwhile, the respective sub-band feedback cancellers (such as sub-band feedback canceller 250a in FIG. 5A) corresponding to sub-band channels without a frequency shift may be programmed in a similar manner as described above in FIG. 2B. Specifically, the adaptation controller 254 for each sub-band feedback canceller corresponding to a sub-band channel without the frequency shift (for example, sub-band feedback canceller 250a), may be configured to (i) select a first adaptation rate for the adaptive filter 256 if a tone is detected by tone detector 252 and if a total gain for the corresponding sub-band channel is greater than threshold, and (ii) select a second adaptation rate that is slower than the first adaptation rate for the adaptive filter 256 if no tone is detected by the tone detector 252 or the total gain for the corresponding sub-band channel is less than the threshold.

FIG. 5C illustrates a table of operating conditions for an audio device 500 in accordance with some embodiments of the present disclosure. The operating matrix in FIG. 5C may be similar to that of FIG. 5B with respect to sub-band channels without a frequency shift, but differ with respect to sub-band channels with a frequency shift. For example, as shown in FIG. 5C, a slow or fast adaptation rate may be selected for sub-band channels with a frequency shift depending on whether a tone is detected.

For example, the respective sub-band feedback cancellers (such as sub-band feedback canceller 250a in FIG. 5A) corresponding to sub-band channels without a frequency shift may be programmed in a similar manner as described above in FIG. 2B. Specifically, the adaptation controller 254 for each sub-band feedback canceller corresponding to a sub-band channel without the frequency shift (for example, sub-band feedback canceller 250a), may be configured to (i) select a first adaptation rate for the adaptive filter 256 if a tone is detected by tone detector 252 and if a total gain for the corresponding sub-band channel is greater than threshold, and (ii) select a second adaptation rate that is slower than the first adaptation rate for the adaptive filter 256 if no tone is detected by the tone detector 252 or the total gain for the corresponding sub-band channel is less than the threshold. Meanwhile, the adaptation controller 254 for each sub-band feedback canceller corresponding to a sub-band channel with the frequency shift (for example, sub-band feedback cancellers 250b and 250n in FIG. 5A), may be configured to (i) select a first adaptation rate for the adaptive filter 256 if no tone is detected by the tone detector 252, and (ii) select a second adaptation rate that is slower than the first adaptation rate for the adaptive filter if the tone is detected by the tone detector 252.

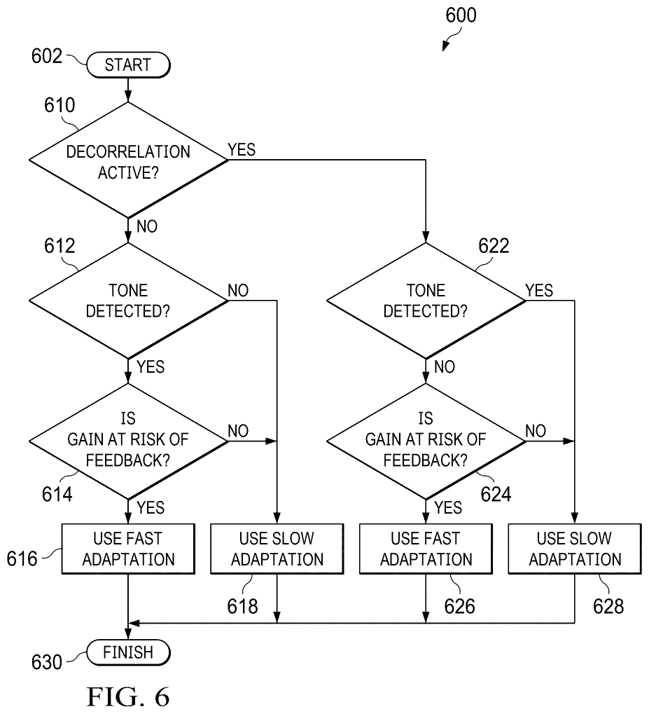

FIG. 6 illustrates a method 600 for operating an audio device in accordance with embodiments of the present disclosure. For example, method 600 may represent a method of operating audio device 500 described above with reference to FIG. 5A.

Method 600 may start at block 602 and proceed to block 610. At block 610, method 600 may determine if decorrelation is active (for example, if a frequency shift is implemented) for a given one of the plurality of sub-band channels 515a-n. For sub-band channels without a frequency shift (for example, sub-band channel 515a in FIG. 5A), method 600 may proceed to block 612. For sub-band channels with a frequency shift (for example, sub-band channels 515b-n in FIG. 5A), method 600 may proceed to block 622.

At block 612, method 600 may determine if a tone is detected. For example, if the tone detector 252 corresponding to the given sub-band channel does not detect a tone, method 600 may proceed to block 618 where a slow adaptation rate may be selected by adaptation controller 254. Conversely, if the tone detector 252 does detect a tone, method 600 may proceed to block 614 to determine whether the total gain level for the sub-band channel is above the maximum stable gain threshold, and thus at risk of causing feedback. If the total forward gain for the sub-band channel is below the maximum stable gain threshold, method 600 may proceed to block 618 where a slow adaptation rate may be selected. Conversely, if the total forward gain for the sub-band channel is above the maximum stable gain threshold, method 600 may proceed to block 616 where a fast adaptation rate may be selected.

As described above, method 600 may proceed from block 610 to 622 for sub-band channels with a frequency shift (for example, sub-band channels 515b-n in FIG. 5A). At block 622, method 600 may determine if a tone is detected. For example, if the tone detector 252 corresponding to the given sub-band channel with the frequency shift detects a tone, method 600 may proceed to block 628 where a slow adaptation rate may be selected by adaptation controller 254. Conversely, if the tone detector 252 does not detect a tone, method 600 may proceed to block 624 to determine whether the total gain level for the sub-band channel is above the maximum stable gain threshold, and thus at risk of causing feedback. If the total forward gain for the sub-band channel is below the maximum stable gain threshold, method 600 may proceed to block 628 where a slow adaptation rate may be selected. Conversely, if the total forward gain for the sub-band channel is above the maximum stable gain threshold, method 600 may proceed to block 626 where a fast adaptation rate may be selected.

After the adaptation rate is selected at any one of blocks 616, 618, 626, and 628, method 600 may proceed to finish at block 630. Although method 600 may complete at block 630, method 600 may repeat itself to continuously update the adaptation rate, for example, based on changing acoustic feedback path conditions. Further, an audio device such as audio device 400 or audio device 500 may run multiple instances of method 600, for example running method 600 for each of the plurality of sub-bands included therein.

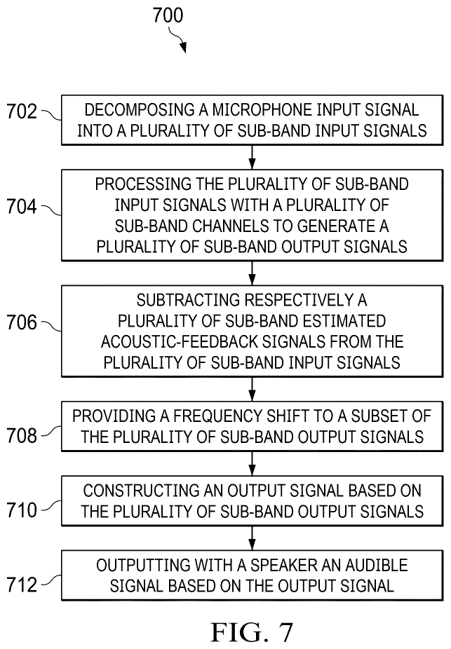

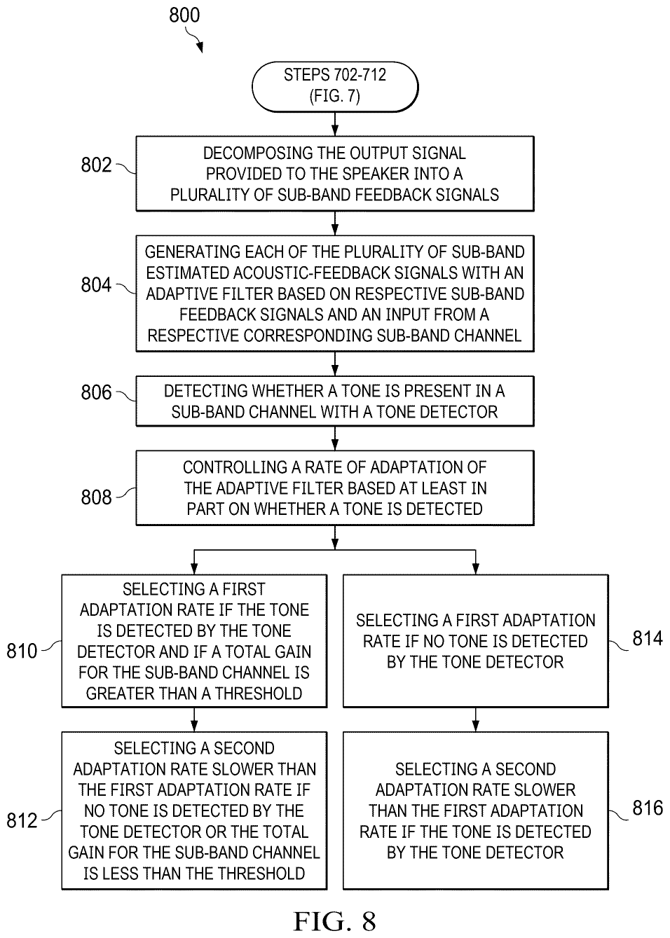

FIG. 7 illustrates a method 700 for operating an audio device in accordance with embodiments of the present disclosure. Method 700 may be performed by any suitable mechanism, such as audio device 400, audio device 500, and/or any suitable combination thereof. Method 700 may be performed with fewer or more steps than shown in FIG. 7. Moreover, steps of method 700 may be omitted, repeated, performed in parallel, performed in a different order than shown in FIG. 7, or performed recursively. One or more steps of method 700, although shown in an order, may be performed at the same time or in a re-ordered manner. For example, steps 706 and 708 may represent specific steps used to perform step 704, and may thus be considered as being performed simultaneously as step 704.

Step 702 may include decomposing a microphone input signal into a plurality of sub-band input signals. For example, as shown in FIG. 5A, input filter bank 210 may decompose a time-domain microphone signal from microphone 110 into an n number of sub-band input signals.

Step 704 may include processing the plurality of sub-band input signals with a plurality of sub-band channels to generate a plurality of sub-band output signals. For example, sub-band channels 515a-n illustrated in FIG. 5A may process the plurality of sub-band input signals from input filter bank 210 to provide a corresponding plurality of sub-band output signals to output filter bank 260. In some embodiments, the processing may include steps 706 and 708 described below.

Step 706 may include subtracting respectively a plurality of sub-band estimated acoustic-feedback signals from the plurality of sub-band input signals. As shown in FIG. 5A, for example, summation circuits 220a-n may subtract respectively a plurality of sub-band estimated acoustic-feedback signals (received from sub-band feedback cancellers 250a-n) from the plurality of sub-band input signals (received from input filter bank 210).

Step 708 may include providing a frequency shift to a subset of the plurality of sub-band output signals. For example, as shown in FIG. 5A, a subset (for example, sub-band channels 515b through 515n) of the plurality of sub-band channels 515a-n may include a respective one of multipliers 435b-n which, in combination with frequency-shift source 490, may provide a frequency shift to the sub-band output signal for that sub-band channel.

Step 710 may include constructing an output signal based on the plurality of sub-band output signals. As shown in FIG. 5A, for example, output filter bank 260 may be configured to construct an output signal based on the plurality of sub-band output signals from the plurality of sub-band channels 515a-n. Specifically, output filter bank 260 may receive the various amplified sub-band output signals from the plurality of sub-band channels 215a-n and reconstruct a time-domain output signal from the sub-band representation.

Step 712 may include outputting with a speaker an audible signal based on the output signal. For example, as shown in FIG. 5A, speaker 140 may generate an audible signal based on the output signal from output filter bank 260 (as limited by limiter circuit 270).

FIG. 8 illustrates a method 800 for operating an audio device in accordance with embodiments of the present disclosure. Method 800 may be performed by any suitable mechanism, such as audio device 500. Method 800 may be performed with fewer or more steps than shown in FIG. 8. Moreover, steps of method 800 may be omitted, repeated, performed in parallel, performed in a different order than shown in FIG. 8, or performed recursively. One or more steps of method 800, although shown in an order, may be performed at the same time or in a re-ordered manner. In some embodiments, method 800 may include steps 702-712 illustrated in FIG. 7, and may further include steps 802-816 as shown in FIG. 8.

Step 802 may include decomposing the output signal provided to the speaker into a plurality of sub-band feedback signals. As shown in FIG. 5A, for example, feedback filter bank 280 may be configured to decompose the output signal provided to speaker 140 into a plurality of sub-band feedback signals, and may provide those sub-band feedback signals to the plurality of sub-band feedback cancellers 250a-n.

Step 804 may include generating each of the plurality of sub-band estimated acoustic-feedback signals with an adaptive filter based on respective sub-band feedback signals and an input from a respective corresponding sub-band channel. As shown in FIG. 5A, for example, each of the plurality of sub-band feedback cancellers 250a-n may include an adaptive filter 256. Each instance of adaptive filter 256 may be coupled to receive a respective sub-band feedback signal (from feedback filter bank 280) and an input from a corresponding one of the plurality of sub-band channels 215a-n. Adaptive filter 256 may thus be configured to generate a respective sub-band estimated acoustic-feedback signal based at least on the respective sub-band feedback signal (from feedback filter bank 280) and an input from a corresponding one of sub-band channels 215a-n.

Step 806 may include detecting whether a tone is present in a sub-band channel with a tone detector. As shown in FIG. 5A, for example, each of the plurality of sub-band feedback cancellers 250a-n may include a tone detector 252 that may detect whether a tone is present in the frequency range of corresponding sub-band.

Step 808 may include controlling a rate of adaptation of the adaptive filter based at least in part on whether a tone is detected. As described above with reference to FIGS. 5A and 5C for example, adaptation controller 254 may control the rate of adaptation for adaptive filter 256 based at least in part on whether a tone is detected by tone detector 252 for the corresponding sub-band.

Method 800 may perform steps 810-812, or alternatively to steps 814-816, based on whether the adaptation controller 254 is part of a sub-band feedback canceller that corresponds to a sub-band channel with or without a frequency shift as described above with reference to FIGS. 5A and 5C for example.

For sub-bands without a frequency shift, method 800 may perform steps 810-812. Step 812 may include selecting a first adaptation rate if the tone is detected by the tone detector and if a total gain for the sub-band channel is greater than a threshold. Step 814 may include selecting a second adaptation rate that is slower than the first adaptation rate if no tone is detected by the tone detector or the total gain for the sub-band channel is less than the threshold. For example, as described above with reference to FIGS. 5A and 5C, the adaptation controller 254 for each sub-band feedback canceller corresponding to a sub-band channel without the frequency shift (for example, sub-band feedback canceller 250a), may be configured to (i) select a first adaptation rate for the adaptive filter 256 if a tone is detected by tone detector 252 and if a total gain for the corresponding sub-band channel is greater than threshold, and (ii) select a second adaptation rate that is slower than the first adaptation rate for the adaptive filter 256 if no tone is detected by the tone detector 252 or the total gain for the corresponding sub-band channel is less than the threshold.

For sub-bands with a frequency shift, method 800 may perform steps 814-816. Step 814 may include selecting a first adaptation rate if no tone is detected by the tone detector. Step 816 may include selecting a second adaptation rate that is slower than the first adaptation rate if the tone is detected by the tone detector. For example, as described above with reference to FIGS. 5A and 5C, the adaptation controller 254 for each sub-band feedback canceller corresponding to a sub-band channel with the frequency shift (for example, sub-band feedback cancellers 250b and 250n in FIG. 5A), may be configured to (i) select a first adaptation rate for the adaptive filter 256 if no tone is detected by the tone detector 252, and (ii) select a second adaptation rate that is slower than the first adaptation rate for the adaptive filter if the tone is detected by the tone detector 252.

Although examples have been described above, other modifications and variations may be made from this disclosure without departing from the spirit and scope of these examples. The above descriptions of various embodiments illustrate the principles of the invention. Numerous variations and modifications will become apparent to those skilled in the art based on the above disclosure. The following claims are intended to embrace all such variations and modifications.

1. An audio device comprising:
a microphone;
an input filter bank configured to decompose a microphone input signal into a plurality of sub-band input signals;
a plurality of sub-band channels configured to process the plurality of sub-band input signals to generate a plurality of sub-band output signals,
wherein each of the plurality of sub-band channels are configured to subtract a respective one of a plurality of sub-band estimated acoustic-feedback signals from a respective one of the plurality of sub-band input signals, and
wherein each of a subset of the plurality of sub-band channels are configured to frequency shift a respective sub-band output signal relative to a corresponding sub-band input signal;
an output filter bank configured to construct an output signal based on the plurality of sub-band output signals; and
a speaker configured to output an audible signal based on the output signal.

2. The audio device of claim 1, wherein the audio device is a hearing aid.

3. The audio device of claim 1, wherein the subset is a proper subset including at least one and less than all of the plurality of sub-band channels.

4. The audio device of claim 1, wherein the frequency shift is constant across each of the subset of the plurality of sub-band channels.

5. The audio device of claim 1, wherein the frequency shift for each of the subset of sub-band channels is in a range of 5 to 25 Hz.

6. The audio device of claim 1, further comprising a limiter circuit coupled between the output filter bank and the speaker and configured to limit the output signal provided to the speaker based on a preprogrammed maximum level.

7. The audio device of claim 1, further comprising:
feedback filter bank configured to decompose the output signal provided to the speaker into a plurality of sub-band feedback signals; and
a plurality of sub-band feedback cancellers configured to respectively generate the plurality of sub-band estimated acoustic-feedback signals.

8. The audio device of claim 7, wherein each of the plurality of sub-band feedback cancellers includes an adaptive filter configured to generate a respective sub-band estimated acoustic-feedback signal based at least on a respective sub-band feedback signal and an input from a corresponding sub-band channel.

9. The audio device of claim 8, wherein each sub-band feedback canceller corresponding to a sub-band channel without the frequency shift further includes:
a tone detector coupled to detect a tone from the corresponding sub-band channel; and
an adaptation controller configured to:
select a first adaptation rate for the adaptive filter if the tone is detected by the tone detector and if a total gain for the corresponding sub-band channel is greater than a threshold; and
select a second adaptation rate that is slower than the first adaptation rate for the adaptive filter if no tone is detected by the tone detector or the total gain for the corresponding sub-band channel is less than the threshold.

10. The audio device of claim 8, wherein each sub-band feedback canceller corresponding to a sub-band channel with the frequency shift further includes:
a tone detector coupled to detect a tone from the corresponding sub-band channel; and
an adaptation controller configured to:
select a first adaptation rate for the adaptive filter if no tone is detected by the tone detector; and
select a second adaptation rate that is slower than the first adaptation rate for the adaptive filter if the tone is detected by the tone detector.

11. An audio device comprising:
a microphone;
an input filter bank configured to decompose a microphone input signal into a plurality of sub-band input signals;
a plurality of sub-band channels configured to process the plurality of sub-band input signals to generate a plurality of sub-band output signals,
wherein each of the plurality of sub-band channels includes a gain circuit coupled to a summation circuit that is configured to subtract a respective one of a plurality of sub-band estimated acoustic-feedback signals from a respective one of the plurality of sub-band input signals; and
wherein each of a subset of the plurality of sub-band channels further includes a multiplier configured to frequency shift a respective sub-band output signal relative to a corresponding sub-band input signal;
an output filter bank configured to construct an output signal based on the plurality of sub-band output signals; and
a speaker configured to output an audible signal based on the output signal.

12. The audio device of claim 11, wherein:
the subset is a proper subset including at least one and less than all of the plurality of sub-band channels; and
the frequency shift is constant across each of the subset of the plurality of sub-band channels.

13. A method for operating an audio device, comprising:
decomposing a microphone input signal into a plurality of sub-band input signals;
processing the plurality of sub-band input signals with a plurality of sub-band channels to generate a plurality of sub-band output signals, wherein the processing includes:
subtracting respectively a plurality of sub-band estimated acoustic-feedback signals from the plurality of sub-band input signals; and
providing a frequency shift to a subset of the plurality of sub-band output signals;
constructing an output signal based on the plurality of sub-band output signals; and
outputting with a speaker an audible signal based on the output signal.

14. The method of claim 13, further comprising:
decomposing the output signal provided to the speaker into a plurality of sub-band feedback signals; and
generating each of the plurality of sub-band estimated acoustic-feedback signals with an adaptive filter based on respective sub-band feedback signals and an input from a respective corresponding sub-band channel.

15. The method of claim 14, further comprising:
detecting whether a tone is present in a sub-band channel with a tone detector; and
controlling a rate of adaptation of the adaptive filter based at least in part on whether a tone is detected.

16. The method of claim 15, further comprising, for one or more adaptive filters corresponding to one or more sub-band channels without a frequency shift:
selecting a first adaptation rate if the tone is detected by the tone detector and if a total gain for the sub-band channel is greater than a threshold; and
selecting a second adaptation rate that is slower than the first adaptation rate if no tone is detected by the tone detector or the total gain for the sub-band channel is less than the threshold.

17. The method of claim 16, further comprising, for one or more adaptive filters corresponding to the subset of the plurality of sub-band channels with a frequency shift:
selecting a first adaptation rate if no tone is detected by the tone detector; and
selecting a second adaptation rate that is slower than the first adaptation rate if the tone is detected by the tone detector.

18. The method of claim 13, wherein the subset is a proper subset including at least one and less than all of the plurality of sub-band channels.

19. The method of claim 13, wherein the frequency shift is constant across each of the subset of the plurality of sub-band channels.

20. The method of claim 13, wherein the frequency shift for each of the subset of sub-band channels is in a range of 5 to 25 Hz.
